(19) United States
(12) Patent Application Publication
(10) Pub. No.: US 2024/0300448 A1
(43) Pub. Date: Sep. 12, 2024

(54) WIPER CONTROLLER

(71) Applicant: DENSO ELECTRONICS CORPORATION, Anjo-city (JP)

(72) Inventor: Tomokatsu FUSEYA, Anjo-city (JP)

(21) Appl. No.: 18/594,039

(22) Filed: Mar. 4, 2024

(30) Foreign Application Priority Data
Mar. 7, 2023 (JP) 2023-034626

(51) Int. Cl. B60S 1/08; B60S 1/16

(52) U.S. Cl. CPC B60S 1/0807; B60S 1/16

(57) ABSTRACT

A wiper controller includes an acquirer and a determiner. The acquirer acquires a value related to an electric current flowing through a wiper motor driving a wiper reciprocating between a first position and a second position. The determiner determines that a position of the wiper is either the first position or the second position based on a temporal change of the electric current flowing through the wiper motor.

### CROSS REFERENCE TO RELATED APPLICATION

This application is based on and claims the benefits of priority of Japanese Patent Application No. 2023-034626 filed on Mar. 7, 2023. The entire disclosure of which is incorporated herein by reference.

### TECHNICAL FIELD

The present disclosure relates to a wiper controller.

### BACKGROUND

A conventional wiper device calculates a position of a wiper blade from a reference position based on a rotation speed of a rotor of a wiper motor detected by a Hall sensor and a speed reduction ratio of a speed reduction mechanism of the wiper motor.

### SUMMARY

According to at least one embodiment, a wiper controller includes an acquirer and a determiner. The acquirer acquires a value related to an electric current flowing through a wiper motor driving a wiper reciprocating between a first position and a second position. The determiner determines that a position of the wiper is either the first position or the second position based on a temporal change of the electric current flowing through the wiper motor.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a configuration diagram of a wiper drive system using a wiper controller of a first embodiment.

FIG. 2 a diagram illustrating a wiper of the wiper drive system.

FIG. 3 is a diagram illustrating a relationship between an electric current flowing through a wiper motor of the wiper drive system and time.

FIG. 4 is a flowchart illustrating processes of a drive unit of the wiper controller.

FIG. 5 is a flowchart illustrating processes of a determiner of the wiper controller.

FIG. 6 is a diagram illustrating a relationship between a smoothed value of an electric current flowing through the wiper motor of the wiper drive system and time.

FIG. 7 is a diagram illustrating a relationship between a smoothed value of an electric current flowing through the wiper motor of the wiper drive system and time.

FIG. 8 is a configuration diagram of a wiper drive system using a wiper controller according to a modification of the first embodiment.

FIG. 9 is a schematic diagram illustrating a wiper for illustrating processes of a determiner according to the modification of the first embodiment.

FIG. 10 is a configuration diagram of a wiper drive system using a wiper controller according to a modification of the first embodiment.

FIG. 11 is a configuration diagram of a wiper drive system using a wiper controller of a second embodiment.

FIG. 12 is a flowchart illustrating processes of a determiner of the wiper controller.

FIG. 13 is a diagram illustrating a relationship between a smoothed value of an electric current flowing through the wiper motor of the wiper drive system and time.

### DETAILED DESCRIPTION

To begin with, examples of relevant techniques will be described.

A wiper device according to a comparative example calculates a position of a wiper blade from a reference position based on a rotation speed of a rotor of a wiper motor detected by a Hall sensor and a speed reduction ratio of a speed reduction mechanism of the wiper motor.

The wiper device of the comparative example includes a Hall sensor that detects a rotation speed of a rotor. As a result, wiring of signals for the Hall sensor is required, and thus the wiper device of the comparative example is complicated. This increases a cost of the wiper device.

According to an aspect of the present disclosure, a wiper controller includes an acquirer and a determiner. The acquirer acquires a value related to an electric current flowing through a wiper motor driving a wiper reciprocating between a first position and a second position. The determiner determines that a position of the wiper is either the first position or the second position based on a temporal change of the electric current flowing through the wiper motor.

As a result, it is determined where the wiper position is located without providing a Hall sensor that detects the rotation speed of the rotor. Therefore, it is not necessary to provide signal wiring for the Hall sensor. Therefore, the wiper position is estimated with a simple configuration.

Hereinafter, embodiments will be described with reference to the drawings. In the following embodiments, the same or equivalent portions are denoted by the same reference numerals, and the description thereof will be omitted.

### First Embodiment

A wiper controller 30 of the present embodiment is used in a wiper drive system 1 of the vehicle. First, the wiper drive system 1 will be described.

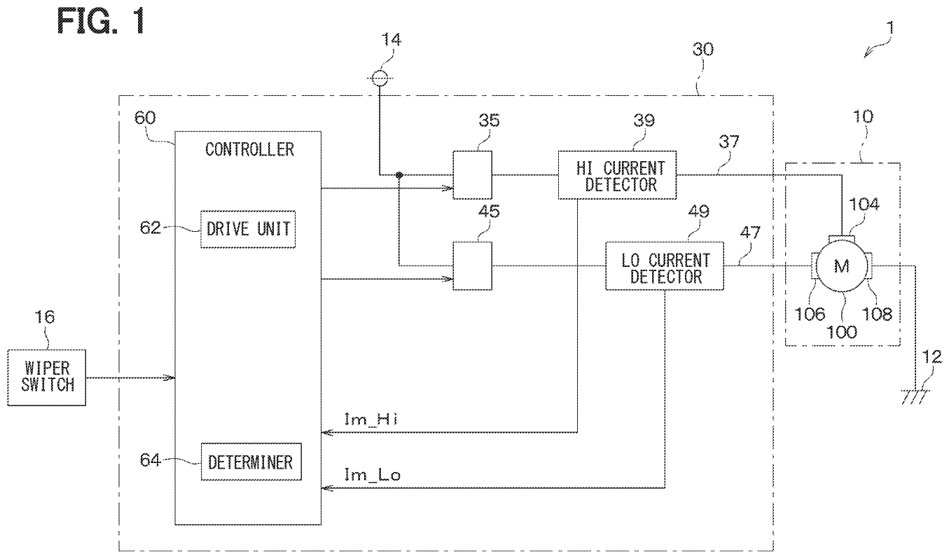

As shown in FIG. 1, the wiper drive system 1 includes a motor unit 10, a motor ground 12, a motor power supply 14, a wiper switch 16, and the wiper controller 30.

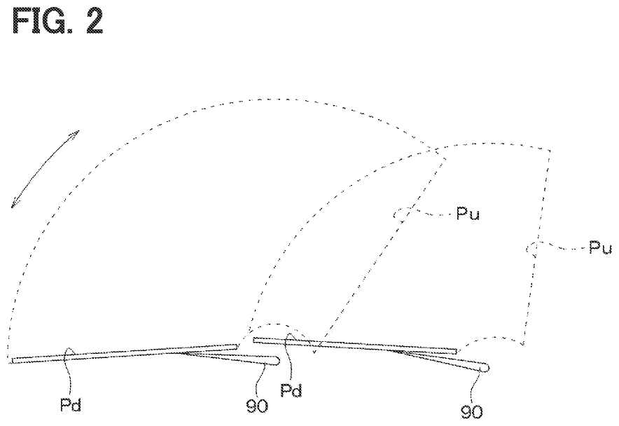

The motor unit 10 includes a wiper motor 100. The wiper motor 100 includes a Hi terminal 104, a Lo terminal 106, and a GND terminal 108. The Hi terminal 104 and the Lo terminal 106 are connected to the wiper controller 30. The GND terminal 108 is connected to the motor ground 12. The wiper motor 100 rotates at a relatively high speed by energization to the Hi terminal 104. When the Lo terminal 106 is energized, the wiper motor 100 rotates at a lower speed than when the Hi terminal 104 is energized. A wiper 90 of the vehicle as shown in FIG. 2 is operated by the rotation of the wiper motor 100 and a link mechanism (not shown) connected to the wiper motor 100.

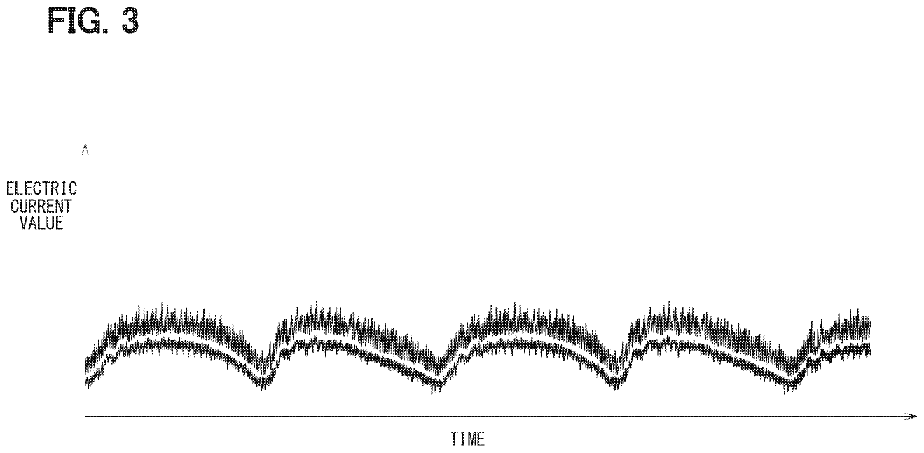

The rotation of the wiper motor 100 causes the wiper 90 to reciprocate between a lower return position Pd and an upper return position Pu on a windshield (not shown). At this time, as shown in FIG. 3, the wiper motor 100 has a characteristic that an electric current flowing through the wiper motor 100 increases or decreases with time by a link mechanism (not shown). Further, an electric current value becomes a local minimum value at the lower return position Pd and the upper return position Pu. Further, the rotation of the wiper motor 100 is stopped so that the wiper 90 stops at the lower return position Pd when the wiper switch 16 is turned off.

Returning to FIG. 1, the motor power supply 14 is a secondary battery such as a lithium ion battery, a nickel hydride battery, or a lead storage battery. A voltage of the motor power supply 14 is, for example, 12 V.

The wiper switch 16 is operated by an operator, and outputs a signal to a controller 60 of the wiper controller 30. The signal is for setting an operation state of the wiper 90 to any one of a continuous high-speed mode, a continuous low-speed mode, an intermittent mode, and a stop.

The wiper controller 30 controls the wiper motor 100 by controlling a voltage applied to the wiper motor 100. Thus, the wiper controller 30 controls driving of the wiper 90 connected to the wiper motor 100. More specifically, the wiper controller 30 includes a Hi switch 35, a Hi wire 37, a Hi current detector 39, a Lo switch 45, a Lo wire 47, a Lo current detector 49, and the controller 60.

The Hi switch 35 includes a relay, a transistor, or the like. One end of the Hi switch 35 is connected to the motor power supply 14. The other end of the Hi switch 35 is connected to the Hi terminal 104 via the Hi wire 37. The Hi switch 35 corresponds to a drive element and is turned on and off by a signal from the controller 60. As a result, the Hi terminal 104 is energized or interrupted.

The Hi current detector 39 includes a shunt resistor, a current mirror circuit, a Hall IC, or the like. The Hi current detector 39 detects a Hi current Im_Hi. Further, the Hi current detector 39 outputs a signal corresponding to the detected Hi current Im_Hi to the controller 60. The Hi current Im_Hi is an electric current flowing from the motor power supply 14 to the Hi terminal 104 via the Hi switch 35 and the Hi wire 37.

The Lo switch 45 includes a relay, a transistor, or the like. One end of the Lo switch 45 is connected to the motor power supply 14. The other end of the Lo switch 45 is connected to the Lo terminal 106 via the Lo wire 47. The Lo switch 45 corresponds to a drive element, and is turned on and off by a signal from the controller 60. As a result, the Lo terminal 106 is energized or interrupted.

The Lo current detector 49 includes a shunt resistor, a current mirror circuit, a Hall IC, or the like. The Lo current detector 49 detects the Lo current Im_Lo. Further, the Lo current detector 49 outputs a signal corresponding to the detected Lo current Im_Lo to the controller 60. The Lo current Im_Lo is an electric current flowing from the motor power supply 14 to the Lo terminal 106 via the Lo switch 45 and the Lo wire 47.

The controller 60 is mainly composed of a computer or the like, and includes a central processing device (i.e., CPU), a read only memory (i.e., ROM), a random access memory (i.e., RAM), an I/O, a bus line for connecting these configurations, and the like. The controller 60 is driven by a voltage from the motor power supply 14 or a power supply (not shown). Further, the controller 60 includes a drive unit 62 and a determiner 64 as functional blocks.

The drive unit 62 executes a program stored in the controller 60 to control ON/OFF of the Hi switch 35 and the Lo switch 45 based on signals from the wiper switch 16 and the determiner 64. Thus, the drive unit 62 controls the voltage applied to the wiper motor 100. Therefore, the operation state of the wiper 90 becomes any one of the continuous high-speed mode, the continuous low-speed mode, the intermittent mode, and the stop.

The determiner 64 determines whether the wiper position Pw is the lower return position Pd or the upper return position Pu based on the signals from the Hi current detector 39 and the Lo current detector 49 by executing a program stored in the controller 60. The determiner 64 outputs a signal corresponding to the determination result to the drive unit 62. The wiper position Pw is a rotational displacement or a position of the wiper 90.

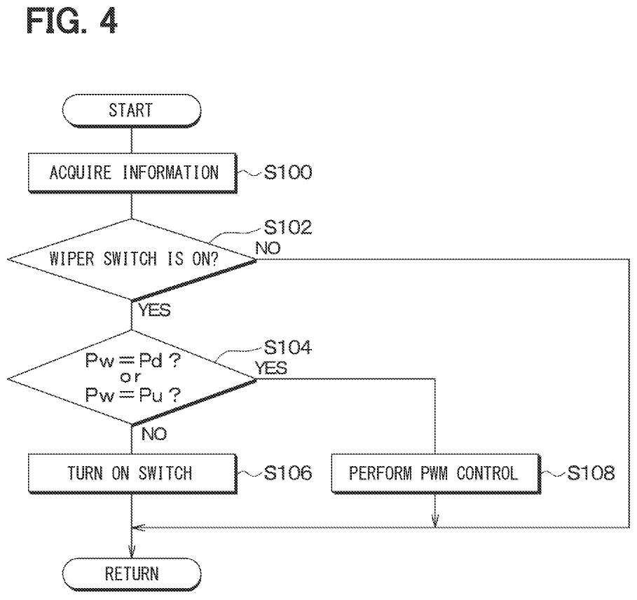

The wiper drive system 1 is configured as described above. Next, control of the voltage applied to the wiper motor 100 in the drive unit 62 by the program execution of the controller 60 will be described with reference to the flowchart of FIG. 4. The program of the controller 60 is executed, for example, when an ignition (not shown) of the vehicle is turned on.

In step S100, the drive unit 62 acquires various types of information. More specifically, the drive unit 62 acquires a signal for setting the operation state of the wiper 90 to the continuous high-speed mode, the continuous low-speed mode, the intermittent mode, and the stop from the wiper switch 16. In addition, the drive unit 62 acquires, from the determiner 64, a signal indicating whether the wiper position Pw is the lower return position Pd or the upper return position Pu.

Subsequently, in step S102, the drive unit 62 determines whether the wiper switch 16 is ON based on the signal from the wiper switch 16 acquired in step S100. The drive unit 62 determines that the wiper switch 16 is turned on when the drive unit 62 acquires a signal for setting the operation state of the wiper 90 to the continuous high-speed mode, the continuous low-speed mode, or the intermittent mode in step S100. Thereafter, the process of the drive unit 62 proceeds to step S104. Further, the drive unit 62 determines that the wiper switch 16 is turned off when the drive unit 62 acquires the signal for stopping the operation state of the wiper 90 in step S100. At this time, since the wiper 90 stops and there is no need to drive the wiper 90, the process of the drive unit 62 returns to step S100.

In step S104 following step S102, the drive unit 62 determines whether the wiper position Pw is the lower return position Pd or the upper return position Pu based on the signal from the determiner 64 acquired in step S100. When the wiper position Pw is not the lower return position Pd or the upper return position Pu, the process of the drive unit 62 proceeds to step S106. When the wiper position Pw is the lower return position Pd or the upper return position Pu, the process of the drive unit 62 proceeds to step S108.

In step S106 following step S104, the drive unit 62 turns on the Hi switch 35 or the Lo switch 45. Thus, the wiper 90 is driven by the rotation of the wiper motor 100.

Here, for example, it is assumed that the wiper switch 16 outputs the signal for setting the operation state of the wiper 90 to the continuous high-speed mode to the drive unit 62 by the operation of the operator. At this time, the drive unit 62 turns on the Hi switch 35. Therefore, the voltage is applied from the motor power supply 14 to the wiper motor 100 via the Hi switch 35, the Hi wire 37, and the Hi terminal 104. As a result, the wiper motor 100 rotates at a higher speed than when the Lo terminal 106 is energized. Therefore, when the wiper 90 connected to the wiper motor 100 rotates at a high speed, the operation state of the wiper 90 becomes the continuous high-speed mode. At this time, the Lo switch 45 is off.

In addition, for example, it is assumed that the wiper switch 16 outputs the signal for setting the operation state of the wiper 90 to the continuous low speed mode to the drive unit 62 by the operation of the operator. At this time, the drive unit 62 turns on the Lo switch 45. Therefore, the voltage is applied from the motor power supply 14 to the wiper motor 100 via the Lo switch 45, the Lo wire 47, and the Lo terminal 106. As a result, the wiper motor 100 rotates at a lower speed than when the Hi terminal 104 is energized. Therefore, when the wiper 90 connected to the wiper motor 100 rotates at a low speed, the operation state of the wiper 90 becomes the continuous low speed mode. At this time, the Hi switch 35 is off. When the wiper 90 is in the intermittent mode, the drive unit 62 turns on the Lo switch 45. As a result, the wiper motor 100 rotates at a low speed. When the wiper 90 reciprocates between the lower return position Pd and the upper return position Pu and the wiper position Pw is at the lower return position Pd, the drive unit 62 turns off the Lo switch 45. Therefore, the wiper motor 100 is temporarily stopped, so that the wiper 90 is temporarily stopped. Thereafter, the drive unit 62 turns on the Lo switch 45. As a result, the wiper motor 100 rotates at a low speed. Therefore, by these operations, the wiper 90 intermittently reciprocates between the lower return position Pd and the upper return position Pu.

In this way, after the drive unit 62 controls the Hi switch 35 and the Lo switch 45, the process of the drive unit 62 returns to step S100.

In step S108 following step S104, the wiper position Pw is the lower return position Pd or the upper return position Pu. Therefore, in step S108, the drive unit 62 performs PWM control on the wiper motor 100 by performing ON/OFF control of the Hi switch 35 or the Lo switch 45. As a result, the drive unit 62 reduces the electric power supplied to the wiper motor 100. Thus, the wiper 90 is decelerated to smoothly move to the lower return position Pd or the upper return position Pu. Therefore, for example, operating noise of the wiper 90 generated when the wiper position Pw is the lower return position Pd or the upper return position Pu is reduced. PWM is an abbreviation for Pulse Width Modulation.

More specifically, the drive unit 62 repeats the operation of turning on the Hi switch 35 for a Hi first time and then turning off the Hi switch 35 for a Hi second time when the operating state of the wiper 90 is the continuous high speed mode. The drive unit 62 repeats the operation of turning on the Lo switch 45 for a Lo first time, and then turning off the Lo switch 45 for a Lo second time, when the operating state of the wiper 90 is the continuous low speed mode. Since the electric power supplied to the wiper motor 100 is reduced by these operations, the wiper 90 is decelerated. Therefore, the wiper 90 is smoothly driven. When the wiper 90 is stopped, the wiper 90 smoothly stops at the lower return position Pd. The Hi first time, the Hi second time, the Lo first time, and the Lo second time are set by experiments, simulations, or the like so that the electric power supplied to the wiper motor 100 is reduced and the wiper 90 is smoothly driven. In addition, by gradually changing the electric power supplied to the wiper motor 100 by changing the Hi first time, the Hi second time, the Lo first time, and the Lo second time, the operation of the wiper 90 becomes smoother.

In this way, after the drive unit 62 performs the on/off control of either the Hi switch 35 or the Lo switch 45, the process of the drive unit 62 returns to step S100.

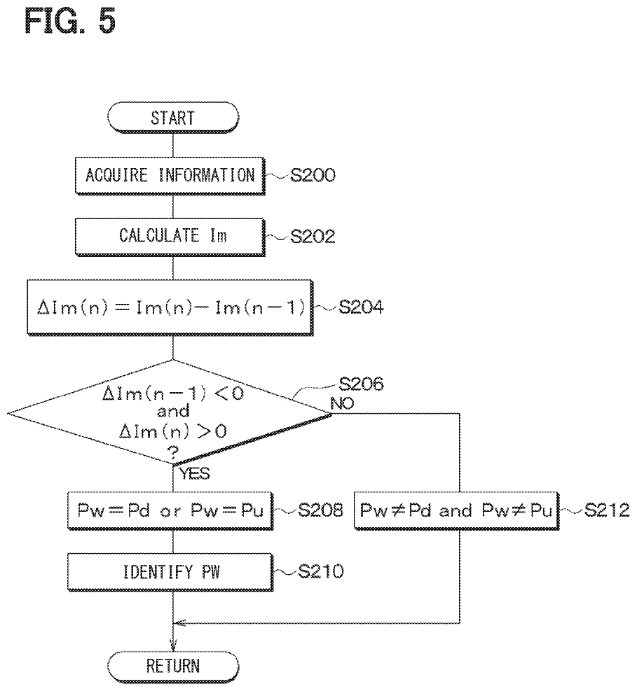

As described above, the drive unit 62 controls the voltage applied to the wiper motor 100. Next, the determination of whether the wiper position Pw is the lower return position Pd or the upper return position Pu in the determiner 64 by the execution of the program by the controller 60 will be described with reference to the flowchart of FIG. 5. A period of a series of operations from the start of the process of step S200 of the determiner 64 to the return to the process of step S200 is defined as a control cycle τ of the determiner 64.

In step S200, the determiner 64 acquires various types of information. More specifically, the determiner 64 acquires the signal for setting the operation state of the wiper 90 to the continuous high-speed mode, the continuous low-speed mode, the intermittent mode, and the stop from the wiper switch 16. The determiner 64 acquires the Hi current Im_Hi from the Hi current detector 39. Further, the determiner 64 acquires the Lo current Im_Lo from the Lo current detector 49.

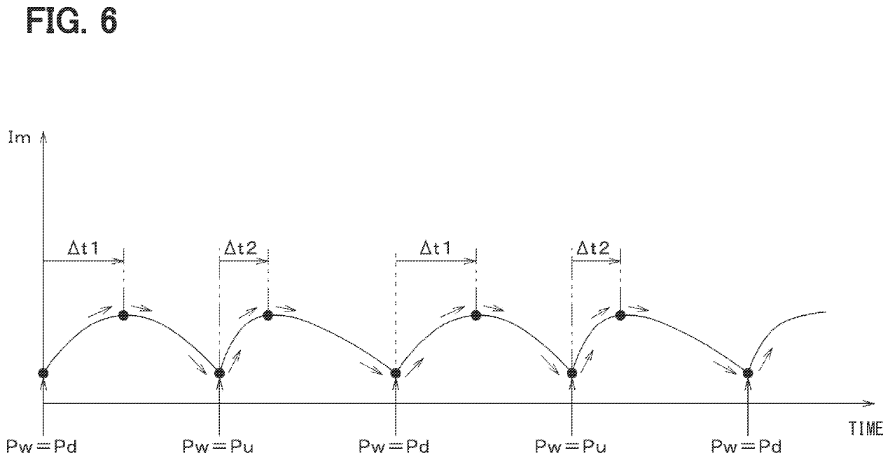

Subsequently, in step S202, when the operation state of the wiper 90 is the continuous high-speed mode, the determiner 64 calculates a smoothed value Im with respect to time in the Hi current Im_Hi acquired in step S200. Thus, as shown in FIG. 6, the Hi current Im_Hi is smoothed with respect to time. When the operation state of the wiper 90 is the continuous low-speed mode or the intermittent mode, the determiner 64 calculates a smoothed value Im with respect to time in the Lo current Im_Lo acquired in step S200. Therefore, the Lo current Im_Lo is smoothed with respect to time. Here, smoothing refers to creating an approximation function that extracts important features of data while eliminating noise and other fine structures or abrupt phenomena in statistics and signal processing. The smoothing is performed using, for example, a simple moving average, a weighted moving average, an exponential moving average, a triangular moving average, a sinusoidal weighted moving average, a cumulative moving average, or the like. Further, the smoothing may be performed using convolution, a KZ filter, an envelope, a moving standard deviation, and the like. The smoothing may be performed using a filter such as an averaging filter, a Gaussian filter, a median filter, a maximum value filter, and a minimum value filter.

The wiper position Pw becomes the lower return position Pd or the upper return position Pu when a change amount Δlm of the smoothed value Im changes from a negative value to a positive value due to characteristics of the link mechanism and the wiper motor 100.

Therefore, as shown in the flowchart of FIG. 5, in step S204 following step S202, the determiner 64 subtracts the smoothed value Im (n−1) in the current control cycle τ (n−1) from the smoothed value Im (n) in the previous current control cycle τ (n). As a result, the determiner 64 calculates the change amount Δlm (n) in the current control cycle τ (n). The change amount Δlm (0) is, for example, zero.

Subsequently, in step S206, the determiner 64 determines whether the change amount Δlm (n−1) calculated in the previous control cycle τ (n−1) is less than zero and the change amount Δlm (n) calculated in the current control cycle τ (n) is greater than zero. Thus, the determiner 64 determines whether the wiper position Pw is the lower return position Pd or the upper return position Pu by determining whether the change amount Δlm has changed from a negative value to a positive value.

When the change amount Δlm (n−1) calculated in the previous control cycle τ (n−1) is less than zero and the change amount Δlm (n) calculated in the current control cycle τ (n) is greater than zero, the process of the determiner 64 proceeds to step S208. When the change amount Δlm (n−1) calculated in the previous control cycle τ (n−1) is less than zero and the change amount Δlm (n) calculated in the current control cycle τ (n) is equal to or less than zero, the process of the determiner 64 proceeds to step S212. Further, when the change amount Δlm (n−1) calculated in the previous control cycle τ (n−1) is equal to or greater than zero and the change amount Δlm (n) calculated in the current control cycle 96 (n) is greater than zero, the process of the determiner 64 proceeds to step S212. When the change amount Δlm (n−1) calculated in the previous control cycle τ (n−1) is greater than or equal to zero and the change amount Δlm (n) calculated in the current control cycle τ (n) is less than or equal to zero, the process of the determiner 64 proceeds to step S212.

In step S208 following step S206, the change amount Δlm changes from a negative value to a positive value. At this time, the wiper position Pw is the lower return position Pd or the upper return position Pu. Therefore, at this time, the determiner 64 determines that the wiper position Pw is the lower return position Pd or the upper return position Pu. Further, the determiner 64 outputs a signal indicating that the wiper position Pw is the lower return position Pd or the upper return position Pu to the drive unit 62.

In step S210 following step S208, the determiner 64 identifies whether the wiper position Pw is the lower return position Pd or the upper return position Pu.

The wiper 90 reciprocates between the lower return position Pd and the upper return position Pu. Therefore, the determiner 64 identifies whether the wiper position Pw is the lower return position Pd or the upper return position Pu based on an initial position of the wiper 90 and the number of times the wiper position Pw is determined to be the lower return position Pd or the upper return position Pu. For example, it is assumed that the initial position of the wiper 90 is the lower return position Pd. At this time, when the wiper 90 is driven, the wiper position Pw becomes the upper return position Pu. This is the first time the change amount Δlm changes from a negative value to a positive value. Thereafter, the wiper position Pw returns from the upper return position Pu to the lower return position Pd. This is a second time when the change amount Δlm changes from the negative value to the positive value. Therefore, the determiner 64 counts the number of times that the wiper position Pw is determined to be the lower return position Pd or the upper return position Pu, and specifies that the wiper position Pw is the upper return position Pu when the counted number of times is an odd number. The determiner 64 specifies that the wiper position Pw is the lower return position Pd when the counted number of times is an even number. The initial position of the wiper 90 is the lower return position Pd, but is not limited thereto. The initial position of the wiper 90 may be the upper return position Pu. Since the wiper 90 may stop between the lower return position Pd and the upper return position Pu due to malfunction of the wiper 90 or the like, the initial position of the wiper 90 may be a position between the lower return position Pd and the upper return position Pu.

As shown in FIG. 6, the change amount Δlm may change from a positive value to a negative value due to the characteristics of the link mechanism (not shown) and the wiper motor 100. A time period from when the wiper position Pw reaches the lower return position Pd to when the change amount Δlm changes from a positive value to a negative value is defined as a first time Δt1. A time period from when the wiper position Pw reaches the upper return position Pu to when the change amount Δlm changes from a positive value to a negative value is defined as a second time Δt2. Depending on the characteristics of the link mechanism and the wiper motor 100, the second time Δt2 is shorter than the first time Δt1.

Therefore, the determiner 64 may specify whether the wiper position Pw is the lower return position Pd or the upper return position Pu based on the first time Δt1 and the second time Δt2. More specifically, the determiner 64 measures a time period from when it was previously determined that the wiper position Pw is the lower return position Pd or the upper return position Pu to when the change amount Δlm changes from the positive value to the negative value. The determiner 64 specifies that the wiper position Pw is the upper return position Pu when the measured time is the first time Δt1. Further, the determiner 64 specifies that the wiper position Pw is the lower return position Pd when the measured time is the second time Δt2. The determiner 64 may specify that the wiper position Pw is the upper return position Pu when the measured time is equal to or greater than a threshold value. Also, the determiner 64 may specify that the wiper position Pw is the lower return position Pd when the measured time is less than a threshold value. Further, the threshold value is set by an experiment, a simulation, or the like so as to specify whether the wiper position Pw is the lower return position Pd or the upper return position Pu.

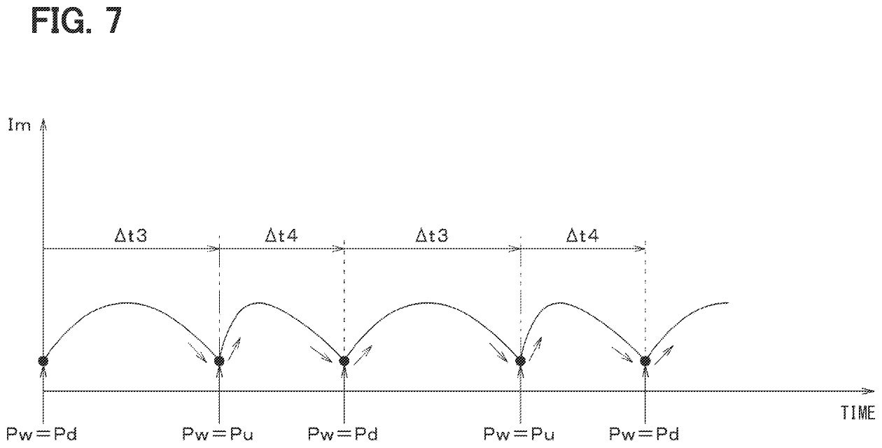

As shown in FIG. 7, a time period from when the wiper position Pw reaches the lower return position Pd to when the wiper position Pw reaches the upper return position Pu is defined as a third time Δt3. Further, a time period from when the wiper position Pw reaches the upper return position Pu to when the wiper position Pw reaches the lower return position Pd is defined as a fourth time Δt4. Depending on the characteristics of the link mechanism and the wiper motor 100, the third time Δt3 is longer than the fourth time Δt4.

Therefore, the determiner 64 may specify whether the wiper position Pw is the lower return position Pd or the upper return position Pu based on the third time Δt3 and the fourth time Δt4. More specifically, the determiner 64 measures a time period from when it was previously determined that the wiper position Pw is the lower return position Pd or the upper return position Pu to when it was currently determined that the wiper position Pw is the lower return position Pd or the upper return position Pu. The determiner 64 specifies that the wiper position Pw is the upper return position Pu when the measured time is the third time Δt3. Further, the determiner 64 specifies that the wiper position Pw is the lower return position Pd when the measured time is the fourth time Δt4. The determiner 64 may specify that the wiper position Pw is the upper return position Pu when the measured time is equal to or greater than a threshold value. Also, the determiner 64 may specify that the wiper position Pw is the lower return position Pd when the measured time is less than a threshold value. Further, the threshold value is set by an experiment, a simulation, or the like so as to specify whether the wiper position Pw is the lower return position Pd or the upper return position Pu.

In this way, after determining which of the lower return position Pd and the upper return position Pu is the wiper position Pw, the determiner 64 outputs a signal corresponding to the determined wiper position Pw to the drive unit 62. Thereafter, the process of the determiner 64 returns to step S200.

In step S212 following step S206, the change amount Δlm has not changed from a negative value to a positive value. At this time, the wiper position Pw is neither the lower return position Pd nor the upper return position Pu. Therefore, at this time, the determiner 64 determines that the wiper position Pw is neither the lower return position Pd nor the upper return position Pu. Further, the determiner 64 outputs a signal indicating that the wiper position Pw is neither the lower return position Pd nor the upper return position Pu to the drive unit 62. Thereafter, the process of the determiner 64 returns to step S200.

As described above, the determiner 64 determines whether the wiper position Pw is the lower return position Pd or the upper return position Pu. Next, estimation of the position of the wiper 90 with a simple configuration in the wiper controller 30 will be described.

In step S200, the determiner 64 serves as an acquirer that acquires a value related to an electric current flowing through the wiper motor 100 that drives the wiper 90 that reciprocates between the lower return position Pd and the upper return position Pu. Further, the determiner 64 determines that the wiper position Pw is one of the lower return position Pd and the upper return position Pu based on a temporal change in the electric current flowing through the wiper motor 100. For example, the determiner 64 determines that the wiper position Pw is either the lower return position Pd or the upper return position Pu when the change amount Δlm of the electric current flowing through the wiper motor 100 changes from a negative value to a positive value in step S206 and step S208. The lower return position Pd corresponds to a first position. The upper return position Pu corresponds to a second position.

As a result, it is determined where the wiper position Pw is located without providing a Hall sensor that detects the rotation speed of the rotor. Therefore, it is not necessary to provide signal wiring for the Hall sensor. Therefore, the wiper position Pw is estimated with a simple configuration. The wiper position Pw may be estimated by a cam switch that is turned on and off according to the rotation of the wiper motor 100. On the other hand, since the wiper controller 30 of the present embodiment estimates the wiper position Pw by the above configuration, the cam switch does not have to be provided.

The wiper controller 30 according to the first embodiment also achieves the following effects.

In step S210, the determiner 64 specifies whether the wiper position Pw is the lower return position Pd or the upper return position Pu based on the first time Δt1 and the second time Δt2. Alternatively, the determiner 64 specifies whether the wiper position Pw is the lower return position Pd or the upper return position Pu based on the initial position of the wiper 90 and the number of times the wiper position Pw is determined to be the lower return position Pd or the upper return position Pu. Alternatively, the determiner 64 specifies whether the wiper position Pw is the lower return position Pd or the upper return position Pu based on the third time Δt3 and the fourth time Δt4.

This makes it easier to specify whether the wiper position is the lower return position Pd or the upper return position Pu.

The drive unit 62 reduces the electric power supplied to the wiper motor 100 when the wiper position Pw is either the lower return position Pd or the upper return position Pu.

As a result, the wiper 90 smoothly moves to the lower return position Pd or the upper return position Pu. Therefore, operating noise of the wiper 90 generated when the wiper position Pw is the lower return position Pd or the upper return position Pu is reduced.

### Modification to First Embodiment

In the first embodiment, the drive unit 62 performs ON/OFF control of the Hi switch 35 or the Lo switch 45 in step S108. As a result, the drive unit 62 reduces the electric power supplied to the wiper motor 100. Contrary to this, means for reducing the electric power supplied to the wiper motor 100 by the drive unit 62 is not limited to the ON/OFF control. For example, the drive unit 62 may reduce the electric power supplied to the wiper motor 100 by controlling a DC-DC converter (not shown) connected to the motor power supply 14 to step down the voltage applied from the motor power supply 14 to the wiper motor 100.

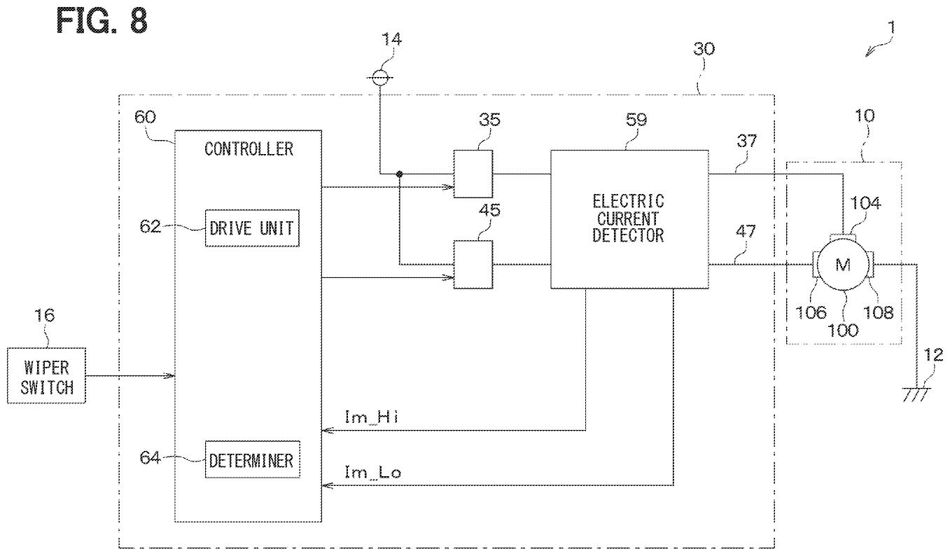

In the first embodiment, the Hi current detector 39 and the Lo current detector 49 are separate units, but the present invention is not limited thereto. As shown in FIG. 8, the Hi current detector 39 and the Lo current detector 49 may be integrated as an electric current detector 59. The electric current detector 59 is disposed between the wiper motor 100 and the Hi and Lo switch 35, 45, but is not limited thereto. For example, the electric current detector 59 may be disposed between the motor power supply 14 and the Hi and Lo switch 35, 45.

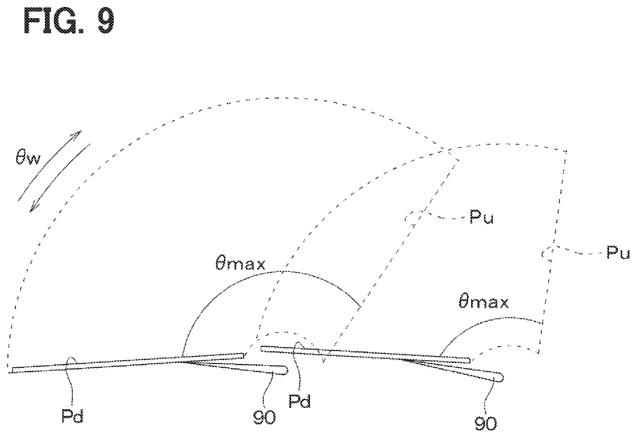

In the first embodiment, in step S210, the determiner 64 specifies whether the wiper position Pw is the lower return position Pd or the upper return position Pu based on the third time Δt3 and the fourth time Δt4. Contrary to this, the determiner 64 may estimate the wiper position Pw by calculating the wiper angle θw as shown in FIG. 9 based on the third time Δt3 and the fourth time Δt4. The wiper angle θw is a rotation angle of the wiper 90. An angle from the lower return position Pd to the upper return position Pu is defined as a maximum angle θmax. The maximum angle θmax is, for example, 140 degrees. A value of the wiper angle θw is in a range of zero to 2×θmax. Further, the wiper position Pw is the lower return position Pd when the wiper angle θw is zero or 2×θmax. The wiper position Pw is the upper return position Pu When the wiper angle θw is θmax. Further, the wiper 90 rotates from the lower return position Pd toward the upper return position Pu when 0<θw<θmax. The wiper 90 rotates from the upper return position Pu toward the lower return position Pd when θmax<θw<2×θmax.

More specifically, for example, the determiner 64 divides the maximum angle θmax by the third time Δt3 to calculate the driving speed of the wiper 90 when the wiper position Pw changes from the lower return position Pd to the upper return position Pu. Further, the determiner 64 calculates the wiper angle θw by multiplying the calculated driving speed of the wiper 90 by the elapsed time period from the lower return position Pd. Thus, the determiner 64 estimates the wiper position Pw. Further, the determiner 64 divides the maximum angle θmax by the fourth time Δt4 to calculate the driving speed of the wiper 90 when the wiper position Pw is changed from the upper return position Pu to the lower return position Pd. Further, the determiner 64 calculates the wiper angle θw by multiplying the calculated driving speed of the wiper 90 by the elapsed time period from the upper return position Pu. Thus, the determiner 64 estimates the wiper position Pw.

Further, from the above estimation, the determiner 64 is capable of determining whether the wiper position Pw is immediately before the lower return position Pd or the upper return position Pu. The drive unit 62 performs the PWM control on the wiper motor 100 by performing the ON/OFF control of the Hi switch 35 or the Lo switch 45 in step S108 when the wiper position Pw is immediately before reaching the lower return position Pd or the upper return position Pu. This enables the wiper 90 to be driven more smoothly. The wiper position Pw being immediately before the lower return position Pd is when the wiper angle θw is equal to or greater than 2×θmax−Δ and less than 2×θmax. Furthermore, the wiper position Pw being immediately before the upper return position Pu is when the wiper angle θw is equal to or greater than θmax−Δ and less than θmax. “Δ” is, for example, 1 to 10 degrees.

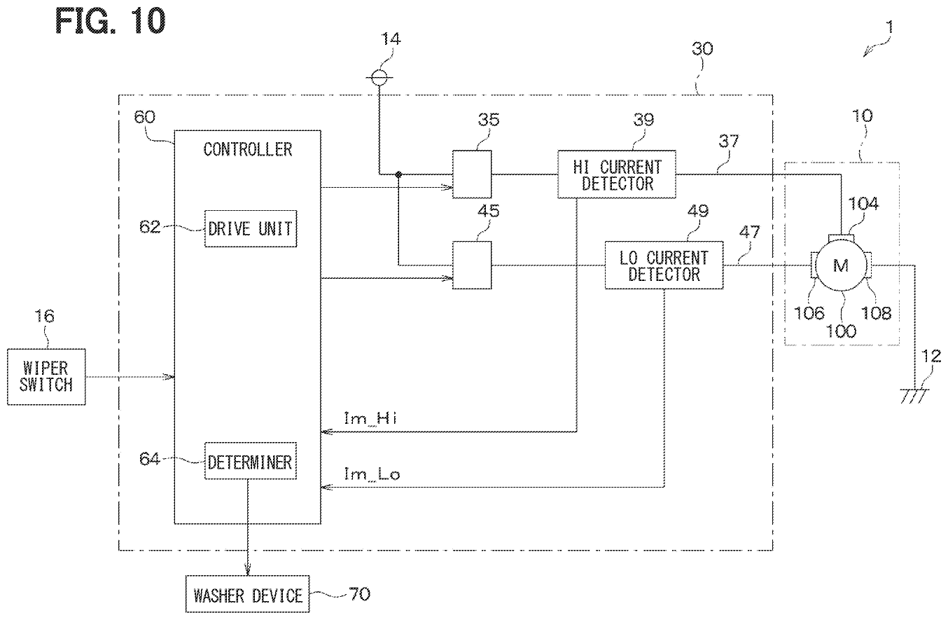

In the first embodiment, when the wiper position Pw is identified to be either the lower return position Pd or the upper return position Pu in step S210, the determiner 64 may output a signal corresponding to the identified wiper position Pw to an external device. For example, the external device is a washer device 70 as shown in FIG. 10. The washer device 70 controls a timing of ejecting washer liquid for cleaning a windshield (not shown) based on the signal from the determiner 64. For example, the washer device 70 ejects washer fluid when the determiner 64 specifies that the wiper position Pw is the lower return position Pd.

### Second Embodiment

In the second embodiment, a configuration of the wiper controller 30 is different from the first embodiment. The determination of whether the wiper position Pw is the lower return position Pd or the upper return position Pu by the determiner 64 is different from the first embodiment. The other components are similar to those of the first embodiment.

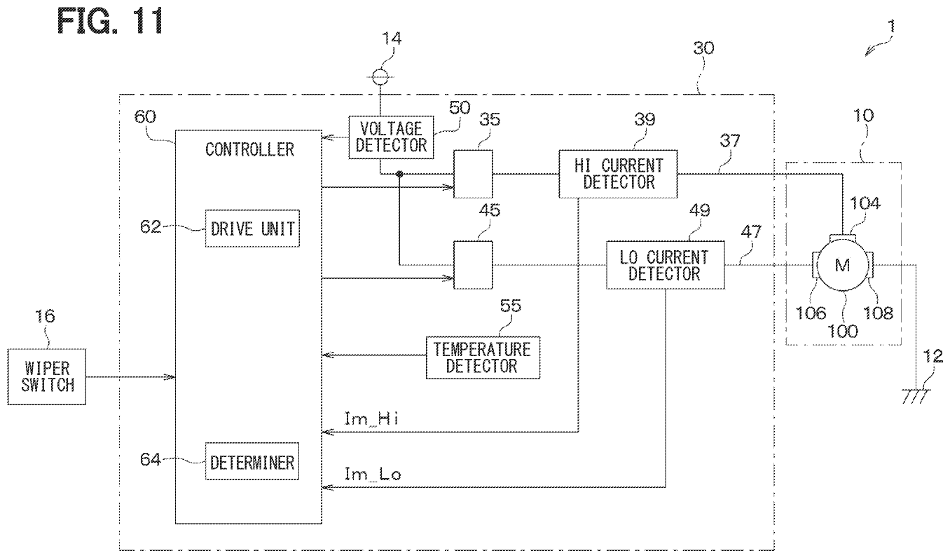

More specifically, as shown in FIG. 11, the wiper controller 30 further includes a voltage detector 50 and a temperature detector 55.

The voltage detector 50 includes a comparator circuit, a DC-DC converter, and the like, and detects a voltage applied from the motor power supply 14 to the wiper motor 100. The voltage detector 50 outputs a signal corresponding to the detected voltage to the determiner 64. The voltage detector 50 is connected between the motor power supply 14 and the Hi and Lo switch 35, 45, but is not limited thereto. For example, the voltage detector 50 may be respectively connected between the Hi switch 35 and the Hi terminal 104 and between the Lo switch 45 and the Lo terminal 106.

The temperature detector 55 includes a thermistor or the like to detect a temperature of the wiper motor 100. Further, the temperature detector 55 outputs a signal corresponding to the detected temperature to the determiner 64.

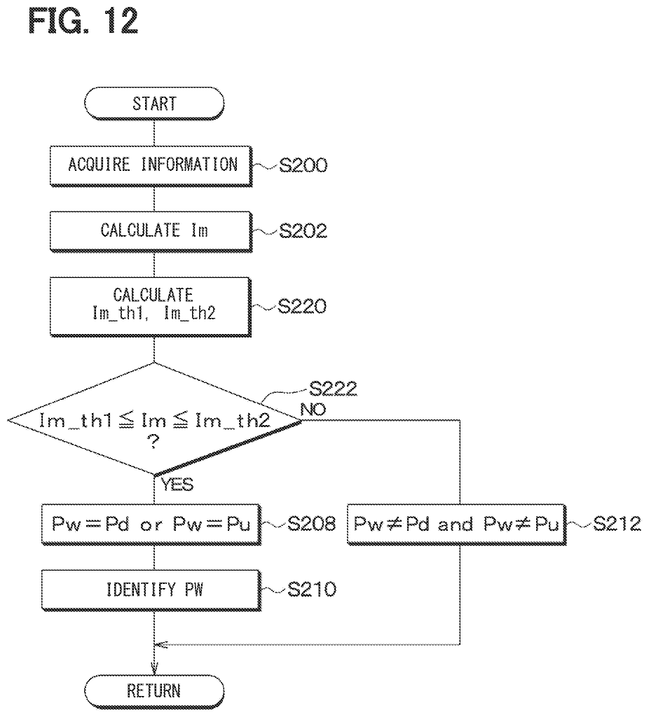

The wiper controller 30 of the second embodiment is configured as described above. Next, the determination of whether the wiper position Pw is the lower return position Pd or the upper return position Pu by the determiner 64 of the second embodiment will be described with reference to the flowchart of FIG. 12.

In step S200, the determiner 64 acquires various types of information. More specifically, similarly to the first embodiment, the determiner 64 acquires the signal from the wiper switch 16, the Hi current Im_Hi, and the Lo current Im_Lo. The determiner 64 acquires, from the voltage detector 50, the voltage applied from the motor power supply 14 to the wiper motor 100. Further, the determiner 64 acquires the temperature of the wiper motor 100 from the temperature detector 55.

Subsequently, in step S202, when the operation state of the wiper 90 is the continuous high-speed mode, the determiner 64 calculates a smoothed value Im with respect to time in the Hi current Im_Hi acquired in step S200. When the operation state of the wiper 90 is the continuous low-speed mode or the intermittent mode, the determiner 64 calculates a smoothed value Im with respect to time in the Lo current Im_Lo acquired in step S200.

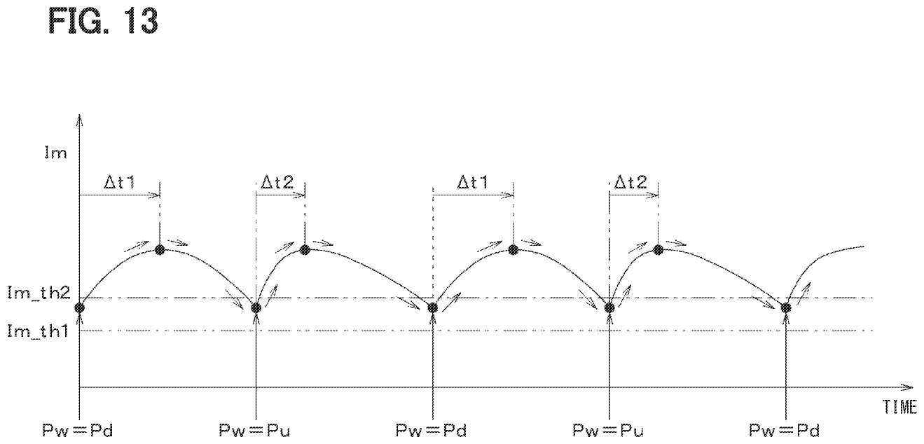

As described above, the wiper position Pw is the lower return position Pd or the upper return position Pu when the change amount Δlm changes from a negative value to a positive value due to the characteristics of the link mechanism and the wiper motor 100. At this time, as shown in FIG. 13, the smoothed value Im is equal to or greater than a first threshold value Im_th1 and equal to or less than a second threshold value Im_th2.

The smoothed value Im changes as the voltage applied from the motor power supply 14 to the wiper motor 100 changes. Further, as the temperature of the wiper motor 100 changes, the smoothed value Im changes. Therefore, the first threshold value Im_th1 and the second threshold value Im_th2 may change according to the voltage applied from the motor power supply 14 to the wiper motor 100 and the temperature of the wiper motor 100.

Therefore, as shown in the flowchart of FIG. 12, in step S220 following step S202, the determiner 64 calculates the first threshold value Im_th1 and the second threshold value Im_th2. More specifically, the determiner 64 calculates the first threshold value Im_th1 and the second threshold value Im_th2 by using a map and the voltage applied from the motor power supply 14 to the wiper motor 100 and the temperature of the wiper motor 100 acquired in step S200. For example, the map is set such that the first threshold value Im_th1 and the second threshold value Im_th2 increase as the voltage applied from the motor power supply 14 to the wiper motor 100 increases. For example, the map is set such that the first threshold value Im_th1 and the second threshold value Im_th2 increase as the temperature of the wiper motor 100 decreases. Further, the map is set by an experiment, a simulation, or the like so as to determine whether the wiper position Pw described later is the lower return position Pd or the upper return position Pu.

Subsequently, in step S222, the determiner 64 determines whether the smoothed value Im calculated in step S202 is equal to or greater than the first threshold value Im_th1 and equal to or less than the second threshold value Im_th2 calculated in step S220. As a result, the determiner 64 determines whether the wiper position Pw is the lower return position Pd or the upper return position Pu.

When the smoothed value Im is equal to or grater than the first threshold value Im_th1 and equal to or less than the second threshold value Im_th2, the process of the determiner 64 proceeds to step S208. When the smoothed value Im is less than the first threshold value Im_th1 or grater than the second threshold value Im_th2, the process of the determiner 64 proceeds to step S212.

In step S208 following step S222, since the smoothed value Im is greater than or equal to the first threshold value Im_th1 and less than or equal to the second threshold value Im_th2, the wiper position Pw is the lower return position Pd or the upper return position Pu. Therefore, at this time, the determiner 64 determines that the wiper position Pw is the lower return position Pd or the upper return position Pu. Further, the determiner 64 outputs a signal indicating that the wiper position Pw is the lower return position Pd or the upper return position Pu to the drive unit 62.

In step S210 following step S208, the determiner 64 identifies whether the wiper position Pw is the lower return position Pd or the upper return position Pu, as in the first embodiment. Therefore, the details of this specification are omitted. After determining which of the lower return position Pd and the upper return position Pu is the wiper position Pw, the determiner 64 outputs a signal corresponding to the determined wiper position Pw to the drive unit 62. Thereafter, the process of the determiner 64 returns to step S200.

In step S212 following step S206, since the smoothed value Im is less than the first threshold value Im_th1 or greater than the second threshold value Im_th2, the wiper position Pw is not the lower return position Pd or the upper return position Pu. Therefore, at this time, the determiner 64 determines that the wiper position Pw is neither the lower return position Pd nor the upper return position Pu. Further, the determiner 64 outputs a signal indicating that the wiper position Pw is neither the lower return position Pd nor the upper return position Pu to the drive unit 62. Thereafter, the process of the determiner 64 returns to step S200.

As described above, the determiner 64 determines whether the wiper position Pw is the lower return position Pd or the upper return position Pu. The second embodiment achieves effects similar to the effects achieved by the first embodiment. The second embodiment also achieves the following effects.

The Hi current Im_Hi, the Lo current Im_Lo, and the smoothed value Im change when the voltage applied to the wiper motor 100 changes. Further, the Hi current Im_Hi, the Lo current Im_Lo, and the smoothed value Im change when the temperature of the wiper motor 100 changes.

Contrary to this, in step S220, the determiner 64 changes the first threshold value Im_th1 and the second threshold value Im_th2 in accordance with a change in the voltage applied to the wiper motor 100. In step S220, the determiner 64 changes the first threshold value Im_th1 and the second threshold value Im_th2 in accordance with a change in the temperature of the wiper motor 100.

As a result, the determiner 64 is prevented from erroneously determining that the smoothed value Im deviates from a range between the first threshold value Im_th1 and the second threshold value Im_th2 even though the wiper position Pw is the lower return position Pd or the upper return position Pu.

### Modification of Second Embodiment

In the second embodiment, similarly to the first embodiment, the first time Δt1 is a time period from when the wiper position Pw reaches the lower return position Pd to when the change amount Δlm changes from a positive value to a negative value. The second time period Δt2 is a time period from when the wiper position Pw reaches the upper return position Pu to when the change amount Δlm changes from a positive value to a negative value.

Contrary to this, the first time Δt1 may be a time from period when the wiper position Pw reaches the lower return position Pd to when the smoothed value Im becomes equal to or greater than the third threshold value. In addition, the second time Δt2 may be a time period from when the wiper position Pw reaches the upper return position Pu to when the smoothed value Im becomes equal to or greater than the third threshold value. In this way, the first time Δt1 and the second time Δt2 may be set without using the change amount Δlm. The third threshold value is set to be grater than the second threshold value Im_th2 and equal to or less than the maximum value of the Hi current Im_Hi or the Lo current Im_Lo.

### Other Embodiments

The present disclosure is not limited to the above-described embodiments, and the above embodiment can be appropriately modified. Individual elements or features of a particular embodiment are not necessarily essential unless it is specifically stated that the elements or the features are essential in the foregoing description, or unless the elements or the features are obviously essential in principle.

The acquirer, the determiner, the drive unit, and the methods thereof described in the present disclosure may be realized by a dedicated computer provided by configuring a processor, programmed to execute one or more functions embodied by a computer program, and a memory. Alternatively, the acquirer, the determiner, the drive unit, and the methods thereof described in the present disclosure may be realized by a dedicated computer provided by configuring a processor with one or more dedicated hardware logic circuits. Alternatively, the determiner, the acquirer, the drive unit, and the methods thereof described in the present disclosure may be realized by one or more dedicated computers configured by a combination of a processor programmed to execute one or more functions, a memory, and a processor configured by one or more hardware logic circuits. A computer program may be stored in a computer-readable non-transitory tangible recording medium as an instruction executed by a computer.

The above-described embodiments may be combined as appropriate.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A wiper controller comprising:
an acquirer configured to acquire a value related to an electric current flowing through a wiper motor driving a wiper reciprocating between a first position and a second position; and
a determiner configured to determine that a position of the wiper is either the first position or the second position based on a temporal change of the electric current flowing through the wiper motor.

2. The wiper controller according to claim 1, wherein
the determiner is configured to determine that the position of the wiper is either the first position or the second position when a change amount of the electric current flowing through the wiper motor changes from a negative value to a positive value.

3. The wiper controller according to claim 1, wherein
the determiner is configured to specify whether the position of the wiper is the first position or the second position based on a time period from when the position of the wiper reaches the first position to when a change amount of the electric current flowing through the wiper motor changes from a positive value to a negative value and a time period from when the position of the wiper reaches the second position to when the change amount of the current flowing through the wiper motor changes from a positive value to a negative value.

4. The wiper controller according to claim 1, wherein
the determiner is configured to specify whether the position of the wiper is the first position or the second position based on an initial position of the wiper and a number of times for which the determiner determines that the position of the wiper is the first position or the second position.

5. The wiper controller according to claim 1, wherein
the determiner is configured to specify whether the position of the wiper is the first position or the second position based on a time period from when the position of the wiper reaches the first position to when the position of the wiper reaches the second position and a time period from when the position of the wiper reaches the second position to when the position of the wiper reaches at the first position.

6. The wiper controller according to claim 1, wherein
the determiner is configured to estimate the position of the wiper based on a time period from when the position of the wiper reaches the first position to when the position of the wiper reaches the second position, an elapsed time period from when the position of the wiper reaches the first position, a time period from when the position of the wiper reaches the second position to when the position of the wiper reaches the first position, and an elapsed time period from when the position of the wiper reaches the second position.

7. A wiper controller comprising:
an acquirer configured to acquire a value related to an electric current flowing through a wiper motor driving a wiper reciprocating between a first position and a second position; and
a determiner configured to determine that the position of the wiper is either the first position or the second position when an electric current flowing through the wiper motor is equal to or greater than a first threshold value and equal to or less than a second threshold value.

8. The wiper controller according to claim 7, wherein
the determiner is configured to change the first threshold value and the second threshold value in accordance with a change in a voltage applied to the wiper motor.

9. The wiper controller according to claim 7, wherein
the determiner is configured to change the first threshold value and the second threshold value in accordance with a change in temperature of the wiper motor.

10. The wiper controller according to claim 1, further comprising
a drive unit configured to reduce electric power supplied to the wiper motor when the position of the wiper is either the first position or the second position.

11. The wiper controller according to claim 10, further comprising
a drive element configured to, when turned on, apply a voltage to the wiper motor to rotate the wiper motor, wherein
the drive unit is configured to reduce the electric power supplied to the wiper motor by turning on and off the drive element when the position of the wiper is either the first position or the second position.
